(19) United States
(12) Patent Application Publication
(10) Pub. No.: US 2019/0180213 A1
(43) Pub. Date: Jun. 13, 2019

(54) COGNITIVE COMPATIBILITY MAPPING

(71) Applicant: International Business Machines Corporation, Armonk, NY (US)

(72) Inventors: Sushil B. Ravi, Visakhapatnam (IN); Venkata Vara Prasad Karri, Visakhapatnam (IN); Kamal K. T. Yamala, Visakhapatnam (IN)

(21) Appl. No.: 15/834,562

(22) Filed: Dec. 7, 2017

(51) Int. Cl. G06Q 10/06

(52) U.S. Cl. CPC G06Q 10/06393

(57) ABSTRACT

According to one embodiment of the present invention, a system processes members of an organization and includes a processor. The system analyzes information pertaining to members of an organization and determines compatibility scores between the members indicating a degree of compatibility. The information includes aspects relating to a compatibility profile and performance of members during interactions with other members. The compatibility profile is based on emotional, social, and cognitive intelligence attributes. One or more groups of compatible members are established based on the compatibility scores between the members. Embodiments of the present invention further include a method and computer program product for processing members of an organization in substantially the same manner described above.

### BACKGROUND

### 1. Technical Field

Present invention embodiments relate to computer processing systems, and more specifically, to analyzing emotional, social, and cognitive intelligence attributes (representing a compatibility profile) of members of an organization to provide recommendations with respect to compatibility.

### 2. Discussion of the Related Art

Work projects of an organization are typically staffed by reviewing qualifications of individuals within the organization. The qualifications may pertain to skills and knowledge of the individual with respect to a work project. However, even with the most relevant individuals assigned to a team for the work project, performance of the team may be undesirable.

### SUMMARY

According to one embodiment of the present invention, a system processes members of an organization and includes a processor. The system analyzes information pertaining to members of an organization and determines compatibility scores between the members indicating a degree of compatibility. The information includes aspects relating to a compatibility profile and performance of members during interactions with other members. The compatibility profile is based on emotional, social, and cognitive intelligence attributes. One or more groups of compatible members are established based on the compatibility scores between the members. Embodiments of the present invention further include a method and computer program product for processing members of an organization in substantially the same manner described above.

### BRIEF DESCRIPTION OF THE DRAWINGS

Generally, like reference numerals in the various figures are utilized to designate like components.

FIG. 1 is a diagrammatic illustration of an example computing environment of a present invention embodiment.

FIG. 2 is a procedural flowchart illustrating a manner of mapping compatibility between members of an organization to form groups according to an embodiment of the present invention.

### DETAILED DESCRIPTION

An embodiment of the present invention employs a blend of performance parities within a defined grouping of members (e.g., employees, etc.) in an organization to correlate data acquired through a human capital management system of the organization. This enables performance of aggregation and correlation mapping of emotional, social, and cognitive intelligence attributes (representing a compatibility profile) of the members to determine an optimum grouping of non-manager and manager members providing a high performance ecosystem. An embodiment of the present invention may be applied to any type of organization to form any desired groups for any activities (e.g., a workforce team for a project, sports or other teams (e.g., managers/coaches, players, etc.) for a sporting or other activity, committees for an organization, forming an organization hierarchy of plural levels of management, groups for political activities, an advisory board, a board of directors, etc.). The organization may include any entity (e.g., company, club, government entity, division or unit of an entity, any pool or collection of members from which to select, etc.).

An embodiment of the present invention determines an emotional and/or cognitive quotient for manager (e.g., employees or members in a management role within the organization, etc.) and non-manager members (e.g., employees or members working for, or subordinate to, manager employees, etc.) of an organization. Mappings are determined between a manager and non-manager member and between a non-manager and manager member to provide effective distribution of organization members. Member performance is evaluated against manager and other non-manager members to determine the mapping. Historical data pertaining to the quotient and mappings identify trends and patterns that are used as feedback for machine learning to improve accuracy of suggestions. An analytical approach is employed to identify empirical evidence through classification of risks and probabilities when volatile teams of contrasting personalities and work styles are being formed. Further, social behavior may be analyzed while working or interacting with a manager or a non-manager member to understand the emotional and behavioral quotient and determine their relevance. Affected dynamics are determined and ranked when multiple parameters, such as criticality of project, location, time, geographies, etc., are introduced. Strategic peer partnerships and employment relationships, including aspects like role topology, mentoring, apprenticeship, training and consultations, are highlighted. Mapping recommendations for manager and non-manager members change over time as non-manager members work or interact with multiple people in projects of different duress. In addition, aggregation and correlation mapping is performed of the emotional, social and cognitive intelligence attributes of the non-manager members.

A relationship analysis and recommendation is presented by an embodiment of the present invention. This utilizes data in an organizational network including a detailed analysis of emotional, social, and cognitive intelligence data of manager members (e.g., pertaining to how they work with their peers and non-manager members), and emotional, social and cognitive intelligence data of non-manager members with regards to performance under each manager member with whom they have worked. A compatibility score is generated by correlating information based on the behavioral, cognitive, social, and emotional quotients of the manager and non-manager members. A result set of a manager member and one or more non-manager members is considered a potential match when the compatibility scores between the manager and non-manager members exceeds a pre-defined configurable threshold. The compatibility score may be used to determine a most optimum arrangement of manager and non-manager members to produce a healthy and efficient work environment which enhances performance dynamics.

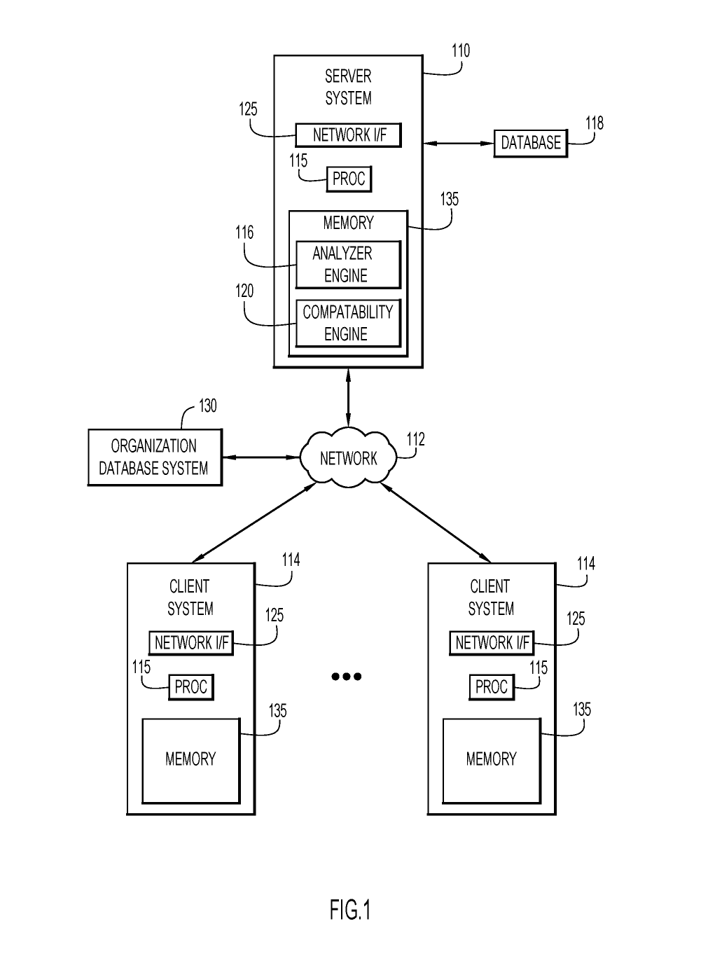

An example environment of a present invention embodiment is illustrated in FIG. 1. Specifically, the environment includes one or more server systems 110, one or more client or end-user systems 114, and an organization database system 130. Server systems 110, client systems 114, and organization database system 130 may be remote from each other and communicate over a network 112. The network may be implemented by any number of any suitable communications media (e.g., wide area network (WAN), local area network (LAN), Internet, Intranet, etc.). Alternatively, server systems 110, client systems 114, and/or organization database system 130 may be local to each other, and communicate via any appropriate local communication medium (e.g., local area network (LAN), hardwire, wireless link, Intranet, etc.).

Client systems 114 enable users to submit requests to server systems 110 to determine compatible members for a group to perform a work project or other activity. The server systems include an analyzer engine 116 to process data from organization database system 130, and a compatibility engine 120 to analyze data and determine compatibility scores for providing recommendations for group members. Analyzer engine 116 may be used to identify and create demographic mappings through computation of key trends in a non-manager member's (e.g., employee, etc.) work pattern to determine satisfaction levels, emotional intelligence, and performance ratings based on time invested in each project working alone versus working with one or more colleagues from any team. Analyzer engine 116 may be further used to dissect metadata to determine underlying relationship patterns where dynamics of a team were affected while being engaged in projects of various natures, challenges and geographies. In addition, the analyzer engine may be used to customize boundaries of a data set and pre-conditions that allow an organization to define the expanse of their analysis.

Compatibility engine 120 may be used to calculate a rationalization behind grouping of various archetypes of manager and non-manager members (e.g., employees and managers), thereby determining a gradient for an optimal banding of teams including manager and non-manager members to produce a high performance ecosystem. The compatibility engine may be further used to identify empirical evidence through classifications of risks and probabilities when volatile teams of contrasting personalities and work styles are being formed. In addition, compatibility engine 120 may be used to influence decision making groups during internal staffing exercises to highlight strategic peer partnerships and employment relationships including aspects such as topology, mentoring, apprenticeship, training, and consultations. The compatibility engine may be used to receive data on a detailed analysis of a manager member's emotional, social and cognitive intelligence pertaining to the manager member's work with peers (or other manager members) and recommending the most compatible team of manager and employees. The need for empirical evidence becomes even more important as this evidence helps in classifications of risks and probabilities when volatile teams of contrasting personalities and work styles are being formed. The evidence further creates the basis for a manager or an employee to understand the rationale behind what has changed and how can team mappings or an employee's morale be improved.

A database system 118 may store various information for the analysis (e.g., compatibility scores, resulting groups, etc.). Organization database system 130 stores information pertaining to members of an organization (e.g., emotional data, social data, cognitive intelligence attributes, performance metrics, roles within the organization, units or divisions, etc.).

Database system 118 and organization database system 130 may be implemented by any conventional or other database or storage unit, may be local to or remote from server systems 110 and client systems 114, and may communicate via any appropriate communication medium (e.g., local area network (LAN), wide area network (WAN), Internet, hardwire, wireless link, Intranet, etc.).

The client systems may present a graphical user (e.g., GUI, etc.) or other interface (e.g., command line prompts, menu screens, etc.) to solicit information from users pertaining to the desired analysis, and may provide reports including analysis results (e.g., resulting groups, compatibility scores, data analytics, etc.).

Server systems 110 and client systems 114 may be implemented by any conventional or other computer systems preferably equipped with a display or monitor, a base, optional input devices (e.g., a keyboard, mouse or other input device), and any commercially available and custom software (e.g., server/communications software, analyzer engine, compatibility engine, browser/interface software, etc.). The base preferably includes at least one hardware processor 115 (e.g., microprocessor, controller, central processing unit (CPU), etc.), one or more memories 135 and/or internal or external network interfaces or communications devices 125 (e.g., modem, network cards, etc.).

Analyzer engine 116 and compatibility engine 120 may include one or more modules or units to perform the various functions of present invention embodiments described below. The various modules (e.g., analyzer engine 116, compatibility engine 120, etc.) may be implemented by any combination of any quantity of software and/or hardware modules or units, and may reside within memory 135 of server systems 110 for execution by processor 115.

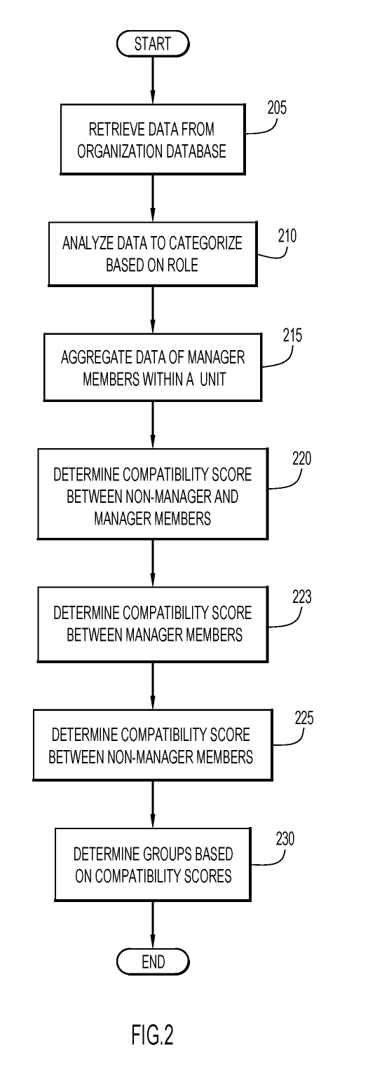

A manner of mapping compatibility between members of an organization to form groups (e.g., via analyzer engine 116, compatibility engine 120, and a server system, 110) according to an embodiment of the present invention is illustrated in FIG. 2. Although FIG. 2 illustrates, by way of example, a linear workflow of acts, these acts may be performed concurrently and, possibly, sporadic at times when data is captured. Initially, a request is received (e.g., from a client system 114) specifying parameters or constraints for forming a group or team of organization members. Analyzer engine 116 retrieves relevant data of organization members from organization database system 130 at step 205. The retrieved data (or metadata associated with organization members) is analyzed at step 210 to determine roles of the organization members (e.g., managerial or other leadership role, non-managerial role, etc.). The data is tagged with the corresponding role, where data of organization members of the same role are stored in respective repositories (e.g., within server system 110 and/or database system 118). For example, a first storage repository may contain organization members tagged as managers (or having a managerial or other leadership role) within an organization, and store member names, performance metrics, and emotional, social and cognitive intelligence attributes. A second repository may contain organization members tagged as non-managers (or having a non-managerial role) within the organization, and store names, performance metrics, and emotional, social and cognitive intelligence attributes. The data of manager members within a common business or other organization unit (e.g., department, division, etc.) may be aggregated at step 215. This may be used to reduce processing time and enhance computing performance by limiting processing to relevant units and manager members.

The information from the repositories are provided to compatibility engine 120 for analysis. This information may include: performance metrics of a non-manager member under each manager member; performance metrics of a team or group of non-manager members under a manager member; emotional, social, and cognitive intelligence attributes of a non-manager member while working with a manager member; emotional, social, and cognitive intelligence attributes of a manager member while working with another manager member and/or a non-manager member; emotional, social and cognitive intelligence attributes of a non-manager member while working with another non-manager member of a same team or group; emotional, social, and cognitive intelligence attributes of a non-manager member while working with another non-manager member of a different team or group; and aggregated data of all manager members within a business or other unit within the organization.

By way of example, the performance metrics may include one or more from the following: a performance rating or score based on performance reviews; scoring dimensions or values; weightings of various metrics indicating significance or importance; comments entered by immediate managers (or manager members), higher level managers (or members with a more significant managerial or leadership role), and other non-manager members (or employees) for a non-manager member (or employee) after a project completion; feedback given by a non-manager member (or employee) for a manager member (or manager); awards, recognitions, and rewards given/received for performance; any discrete or adhoc feedback received by the manager member (or manager) or non-manager member (or employee) in an email or other communication from customers; and year over year (YoY) calculations of manager member (or manager) and non-manager member (or employee) performance/ratings. However, these metrics may vary depending on parameters captured by various performance, feedback, and/or recognition systems.

The various performance metrics may include a numerical rating or score. These scores may be normalized to a common range. However, feedback, comment, communications, and other textual information may be analyzed by Natural Language Processing (NLP) techniques to determine sentiment, affinity (positive, negative, etc.), and other indicators of performance. These aspects may converted to a score (e.g., within the normalized range, etc.) to enable determination of a compatibility score from the performance metrics as described below.

By way of further example, the social, emotional, and cognitive intelligence attributes (representing a compatibility profile for a member) may include one or more from the following: tonal and emotional analysis of comments provided by peers and manager and non-manager members (e.g., managers and employees, etc.), and responses to the comments by the manager member or the non-manager member to whom the comments pertain; location/region, culture, educational background, affiliations, certifications, cause and interests; worked with another under same manager member; performance criteria and work output while working with various combinations of manager and non-manager members (e.g., managers and employees) in multiple projects of varying timelines and duress; and metrics when working on a familiar area or expertise versus when working in an unfamiliar environment. However, there may be various other attributes depending on the organization, culture, and particular market. New reference points may be added, where machine learning may be employed based the metrics and/or attributes to provide additional metrics and/or attributes.

The various attributes may include a numerical rating or score. These scores may be normalized to a common range. However, comments, responses, and other textual information may be analyzed by Natural Language Processing (NLP) techniques to determine sentiment, affinity (positive, negative, etc.), and other indicators of social, emotional, and cognitive intelligence. These aspects may converted to a score (e.g., within the normalized range, etc.) to enable determination of a compatibility score from these attributes as described below.

Compatibility engine 120 analyzes the information to determine effects on performance of non-manager members (or employees) during a time period while working with a manager member (or manager). In addition, compatibility engine 120 may analyze the information to determine effects on performance of manager members (or managers) during a time period while working with another manager member. These determinations may be based on organization appraisal or assessment metrics, such as the metrics and attributes described above. For example, several metrics and/or attributes may be analyzed over the time period to identify changes within the metrics and/or attributes while a member works or interacts with another member. These changes indicate the effects on performance and the compatibility profile of the member while working or interacting with another member. A compatibility score for the non-manager member with respect to the manager is determined based on the performance effects at step 220. A compatibility score for the manager member with respect to another manager member may also be determined based on the performance effects at step 223.

The compatibility score between manager members and between non-manager members and a manager member may be determined based on various logical blocks or patterns specifying the metrics and attributes to be considered. The blocks may further include a weighting for each specified metric and/or attribute to indicate significance of the metric and/or attribute with respect to the compatibility score. For example, a logical block or pattern may specify one or more performance metrics and/or one or more social, emotional and cognitive intelligence attributes, each with a corresponding weighting. The metrics and/or attributes each preferably include a value indicating a corresponding measure of the performance and/or social aspect for a corresponding member as described above. The change in the values of the metrics and/or attributes specified in the logical block over the period of time the member worked or interacted with another member may be determined. The weights for the metrics and/or attributes may be applied to the corresponding value changes to produce a weighted sum that represents the compatibility score. However, any measurements or statistical or other techniques may be employed to determine change in these metrics and/or attributes over time (e.g., regression analysis, etc.). Thus, a non-manager member has a compatibility score for each manager member, preferably with whom they have worked, while a manager member may have a compatibility score for other manager members with whom they have worked.

By way of example, the compatibility score may be negative indicating a decrease in performance for the member with respect to another member, where the magnitude of the compatibility score provides a measure of the amount of decreased performance. Further, the compatibility score may be positive indicating an increase in performance for the member with respect to another member, where the magnitude of the compatibility score provides a measure of the amount of increased performance. The logical blocks or patterns may be customized based on the particular scenario.

Similarly, the compatibility engine determines effects on performance of non-manager members (or employees) during a time period while working or interacting with another non-manager member (or another employee). This determination may be based on organization appraisal or assessment metrics, such as the metrics and attributes described above. For example, several metrics and attributes may be analyzed over the time period to identify changes within the metrics and attributes while the non-manager member works with the other non-manager member. These changes indicate the effects on performance and the compatibility profile of the non-manager member while working or interacting with the other non-manager member. A compatibility score for the non-manager member with respect to the other non-manager member is determined at step 225.

The compatibility score between non-manager members and other non-manager members may be determined based on various logical blocks or patterns specifying the metrics and attributes to be considered. The blocks may further include a weighting for each specified metric and/or attribute to indicate significance of the metric and/or attribute with respect to the compatibility score. For example, a logical block or pattern may specify one or more performance metrics and/or one or more social, emotional and cognitive intelligence attributes, each with a corresponding weighting. The metrics and/or attributes each preferably include a value indicating a corresponding measure of the performance and/or social aspect for a corresponding non-manager member as described above. The change in the values of the metrics and/or attributes specified in the logical block over the period of time the non-manager member worked or interacted with another non-manager member may be determined. The weights for the metrics and/or attributes may be applied to the corresponding value changes to produce a weighted sum that represents the compatibility score. However, any measurements or statistical or other techniques may be employed to determine change in these metrics and/or attributes over time (e.g., regression analysis, etc.). Thus, a non-manager member has a compatibility score for each other non-manager member, preferably with whom they have worked.

By way of example, the compatibility score may be negative indicating a decrease in performance for the non-manager member with respect to another non-manager member, where the magnitude of the compatibility score provides a measure of the amount of decreased performance. Further, the compatibility score may be positive indicating an increase in performance for the non-manager member with respect to the other non-manager member, where the magnitude of the compatibility score provides a measure of the amount of increased performance. The logical blocks or patterns may be customized based on the particular scenario.

The compatibility scores between the members are compared to corresponding thresholds to determine compatibility between manger members and other manager members, between non-manager members and manager members (e.g., managers and employees, etc.), and between non-manager members and other non-manager members (e.g., employees and other employees, etc.). Thus, the results of this provide manager members that are compatible with each other, non-manager members that are compatible with each other, and non-manager members that are compatible with each manager member. The thresholds for compatibility may be the same or different depending upon the types of members for which compatibility is being measured (e.g., between manager members (or managers), between non-manager members (or employees), between manager and non-manager members (managers and employees), etc.). For example, a compatibility score above a threshold indicates compatibility between the corresponding organization members (e.g., manager and non-manager employee, non-manager employee and another non-manager employee, etc.). However, the compatibility score may be compared to the threshold in any manner to indicate compatibility (e.g., greater than, greater than or equal to, less than, less than or equal to, etc.). The thresholds may be defined by the organization or entity forming the teams or groups based on the values or needs of the organization or entity to ensure that actions may be pursued at the appropriate time. The organization or entity selects facets of the metrics and/or attributes to be considered and used to determine the threshold. Further, the threshold may be selected based on a desired sensitivity to compatibility when forming groups, or may be dynamically adjusted to provide determination of more or less groups (depending on the quantity of groups recommended).

The compatibility scores are utilized to form one or more groups or teams of compatible members at step 230. Compatibility scores of manager members, of compatible pairs of non-manager members (e.g., employees), and of pairs of non-manager members and manager members (e.g., managers and employees) are analyzed to form the one or more groups. Each group includes a manager member (compatible with each of the non-manager members of that group), and one or more non-manager members (each compatible with the manager member and the other non-manager members of that group). Each group is formed based on compatibility scores between members of that group being similar, and may further be based on compatibility scores of manager members. For example, the compatibility scores between members of a group may be within a certain range (e.g., a numeric range, a percentage range, etc.) of each other. Further, the compatibility score of a manager member may be examined to select a manager member that has greater compatibility with others beyond members of the group. Moreover, the compatibility score of a manger member may be used to select non-manager members when insufficient information may be present. By way of example, a non-manager member may be selected for a group based on the manager member in the group being compatible with a manager member with whom the selected member had positively interacted. When a quantity of compatible members exceed the desired amount of members for a team or group, the organization members of the desired amount with the closest compatibility scores to other group members may be selected for the group. The one or more groups are recommended, and presented for selection to a user (e.g., on a client system 114).

Compatibility engine 120 may further provide recommendations for additional members to add to a group (e.g., based on compatibility scores, etc.). In addition, the compatibility engine may determine and recommend an optimal group from among a plurality of recommended groups based on compatibility scores and/or other metrics and/or attributes. Compatibility engine 120 may further employ machine learning to determine organization members for a group. In this case, groups selected by a user may be stored, and/or metrics and/or attributes of the members within the group may be tracked. This information may be processed to learn user preferences and/or adjust compatibility scores for recommending groups. Further, the compatibility engine may employ machine learning to provide additional metrics and/or attributes (or adjust the logic blocks or patterns) based on the metrics and/or attributes used for selected groups. Compatibility engine 120 may employ various models to perform the learning (e.g., neural networks, mathematical/statistical models, classifiers, etc.). For example, a compatibility score may indicate compatibility between organization members. However, for some reasons, these organization members may not work well with each other. Alternatively, a group may attain a higher compatibility score, but not be selected by a user. The compatibility engine may learn these aspects and employ them to adjust compatibility scores, logic blocks, and/or to select and/or recommend groups.

It will be appreciated that the embodiments described above and illustrated in the drawings represent only a few of the many ways of implementing embodiments for cognitive compatibility mapping.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software (e.g., browser software, communications software, server software, analyzer engine, compatibility engine, etc.). These systems may include any types of monitors and input devices (e.g., keyboard, mouse, voice recognition, etc.) to enter and/or view information.

It is to be understood that the software (e.g., analyzer engine, compatibility engine, etc.) of the present invention embodiments may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., analyzer engine, compatibility engine, etc.) may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., compatibility scores, result sets, etc.). The database system and organization database system may be implemented by any number of any conventional or other databases, data stores or storage structures (e.g., files, databases, data structures, data or other repositories, etc.) to store information. The database systems may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., resulting groups, compatibility scores, data analytics, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The report may include any information arranged in any fashion, and may be configurable based on rules or other criteria to provide desired information to a user (e.g., resulting groups, compatibility scores, etc.).

The present invention embodiments are not limited to the specific tasks or algorithms described above, but may be utilized for forming any quantity of groups with any quantity of members for any desired activity (e.g., work project, task, sporting activity, audit/investigation, etc.) based on any desired measures of compatibility and performance. The organization may be any type of entity or collection of members. The members may include any type of role within the organization or collection (e.g., leadership, subordinate, etc.). The compatibility may be determined between any members of any roles within the organization or collection. Members of a group may have compatibility scores within any desired ranges. Any quantity of any desired performance, emotional, or other attributes may be used to determine compatibility scores. The groups may have any quantity of members of any roles within the organization or collection. The metrics and attributes may be assigned any suitable values in any value range to indicate a measurement. The determined groups may be presented to a user for selection, or the system may select or indicate a preferred group. The machine learning may adjust recommendations, group members, compatibility scores, and/or metrics and/or attributes to consider based on user preferences (e.g., user selections of groups, etc.) and/or a history of changes to the metrics and/or attributes.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of processing members of an organization comprising:
analyzing, via a processor, information pertaining to members of an organization and determining compatibility scores between the members indicating a degree of compatibility, wherein the information includes aspects relating to a compatibility profile and performance of members during interactions with other members, and wherein the compatibility profile is based on emotional, social, and cognitive intelligence attributes; and
establishing, via a processor, one or more groups of compatible members based on the compatibility scores between the members.

2. The method of claim 1, wherein the members include manager members with a managerial role within the organization and non-manager members, and determining compatibility scores further comprises:
determining compatibility scores between manager members and other manager members;
determining compatibility scores between manager members and non-manager members; and
determining compatibility scores between non-manager members and other non-manager members.

3. The method of claim 2, wherein each group comprises a manager member and one or more non-manager members.

4. The method of claim 1, wherein the compatibility scores are determined based on changes in performance metrics and compatibility profile attributes during the interactions.

5. The method of claim 1, wherein the compatibility scores for members of a group are within a certain range from each other.

6. The method of claim 1, wherein establishing one or more groups comprises:
learning, via the processor, preferred groups based on prior selection of groups.

7. The method of claim 6, wherein learning further comprises:
adjusting compatibility scores for members based on members within the prior selected groups.

8. A system for processing members of an organization comprising:
a processor configured to:
analyze information pertaining to members of an organization and determine compatibility scores between the members indicating a degree of compatibility, wherein the information includes aspects relating to a compatibility profile and performance of members during interactions with other members, and wherein the compatibility profile is based on emotional, social, and cognitive intelligence attributes; and
establish one or more groups of compatible members based on the compatibility scores between the members.

9. The system of claim 8, wherein the members include manager members with a managerial role within the organization and non-manager members, and determining compatibility scores further comprises:
determining compatibility scores between manager members and other manager members;
determining compatibility scores between manager members and non-manager members; and
determining compatibility scores between non-manager members and other non-manager members.

10. The system of claim 9, wherein each group comprises a manager member and one or more non-manager members.

11. The system of claim 8, wherein the compatibility scores are determined based on changes in performance metrics and compatibility profile attributes during the interactions.

12. The system of claim 8, wherein the compatibility scores for members of a group are within a certain range from each other.

13. The system of claim 8, wherein establishing one or more groups comprises:
learning preferred groups based on prior selection of groups; and
adjusting compatibility scores for members based on members within the prior selected groups.

14. A computer program product for processing members of an organization, the computer program product comprising a computer readable storage medium having program instructions embodied therewith, the program instructions executable by a processor to cause the processor to:
analyze information pertaining to members of an organization and determine compatibility scores between the members indicating a degree of compatibility, wherein the information includes aspects relating to a compatibility profile and performance of members during interactions with other members, and wherein the compatibility profile is based on emotional, social, and cognitive intelligence attributes; and
establish one or more groups of compatible members based on the compatibility scores between the members.

15. The computer program product of claim 14, wherein the members include manager members with a managerial role within the organization and non-manager members, and determining compatibility scores further comprises:
determining compatibility scores between manager members and other manager members;
determining compatibility scores between manager members and non-manager members; and
determining compatibility scores between non-manager members and other non-manager members.

16. The computer program product of claim 15, wherein each group comprises a manager member and one or more non-manager members.

17. The computer program product of claim 14, wherein the compatibility scores are determined based on changes in performance metrics and compatibility profile attributes during the interactions.

18. The computer program product of claim 14, wherein the compatibility scores for members of a group are within a certain range from each other.

19. The computer program product of claim 14, wherein establishing one or more groups comprises:
learning preferred groups based on prior selection of groups.

20. The computer program product of claim 19, wherein learning further comprises:
adjusting compatibility scores for members based on members within the prior selected groups.
